(19) United States
(12) Patent Application Publication
(10) Pub. No.: US 2020/0242513 A1
(43) Pub. Date: Jul. 30, 2020

(54) TECHNOLOGIES FOR IMPLEMENTING SYSTEM FOR AGGREGATING DATA AND PROVIDING AN APPLICATION

(71) Applicant: WBKM Limited, Concord (CA)

(72) Inventors: Macksim BLAYVAS, Vaughan (CA); Dimitry BEHAK, Toronto (CA)

(21) Appl. No.: 16/753,061

(22) PCT Filed: Oct. 3, 2018
(86) PCT No.: PCT/EP2018/076890

§ 371 Date: Apr. 2, 2020

Related U.S. Application Data
(60) Provisional application No. 62/567,590, filed on Oct. 3, 2017.

(51) Int. Cl. G06N 20/00; G06F 9/54; G06Q 30/02

(52) U.S. Cl. CPC G06N 20/00; G06Q 30/0242; G06F 9/54

(57) ABSTRACT

A system for acquisition and retention of users for an application. The system identifies a trait of a potential user for the application and filters a plurality marketing campaigns based on the identified trait of the potential user. The server implements the filtered marketing campaign to reach the potential user. The server receives user information in response to acquisition of a new user. The server performs an analysis on the new user's application behavior to generate user related data. The server generates a predefined report based on the user related data.

### BACKGROUND

The present disclosure relates to systems, components, and methodologies for implementing a system for aggregating data and providing an application. More particularly, the present disclosure relates to systems, components, and methodologies that perform rapid application software development, manage application parameters, user acquisition and retention and perform analysis on generated data to understand trends of the users.

### SUMMARY

The present disclosure may comprise one or more of the following features and combinations thereof.

According to the present disclosure, systems, components, and methodologies are provided for aggregating data and providing an application.

In illustrative embodiments, a system for aggregating data and providing an application may perform user data management, application parameter management, mass mailing, push notifications, user acquisition and user retention by analyzing aggregated data to determine trends among the users. The identified trends may provide insight on whether a user may abandon the application in the future. To combat this, in some embodiments, the system may generate incentive packages to retain users by giving benefits and special rates for the users based upon life time value of the user. The system may generate reports on the collected data from the identified trends and third party providers. In addition, during implementation of the application, fraud detection tools may be used to monitor user application behavior to ensure no fraud is committed by the users.

In at least one embodiment, the application may be designed for at least one iOS, Android, PC, TV, Game console or web-integrated application.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

For the purposes of promoting an understanding of the principles of the disclosure, reference will now be made to a number of illustrative embodiments illustrated in the drawings and specific language will be used to describe the same.

The detailed description particularly refers to the accompanying figures in which:

FIG. 1 is a simple diagram illustrating an example system for aggregating data and providing an application in accordance with the present disclosure;

FIG. 2 is an simple diagram of at least one embodiment of an environment of a primary server of FIG. 1 in accordance with the present disclosure;

FIG. 3 is a simplified flow diagram of at least one embodiment of a method for configuring an application and receiving feedback from a user that may be executed by the primary server of FIGS. 1 and 2 in accordance with the present disclosure;

FIGS. 4, 5, and 6 are a simplified flow diagram of at least one embodiment of a method for acquiring users, retaining users, and generating reports that may be executed by the primary server of FIGS. 1 and 2 in accordance with the present disclosure; and

FIG. 7 is a simplified flow diagram of at least one embodiment of a method for establishing a session with the user and monitor application data for fraud that may be executed by the primary server of FIGS. 1 and 2 in accordance with the present disclosure.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

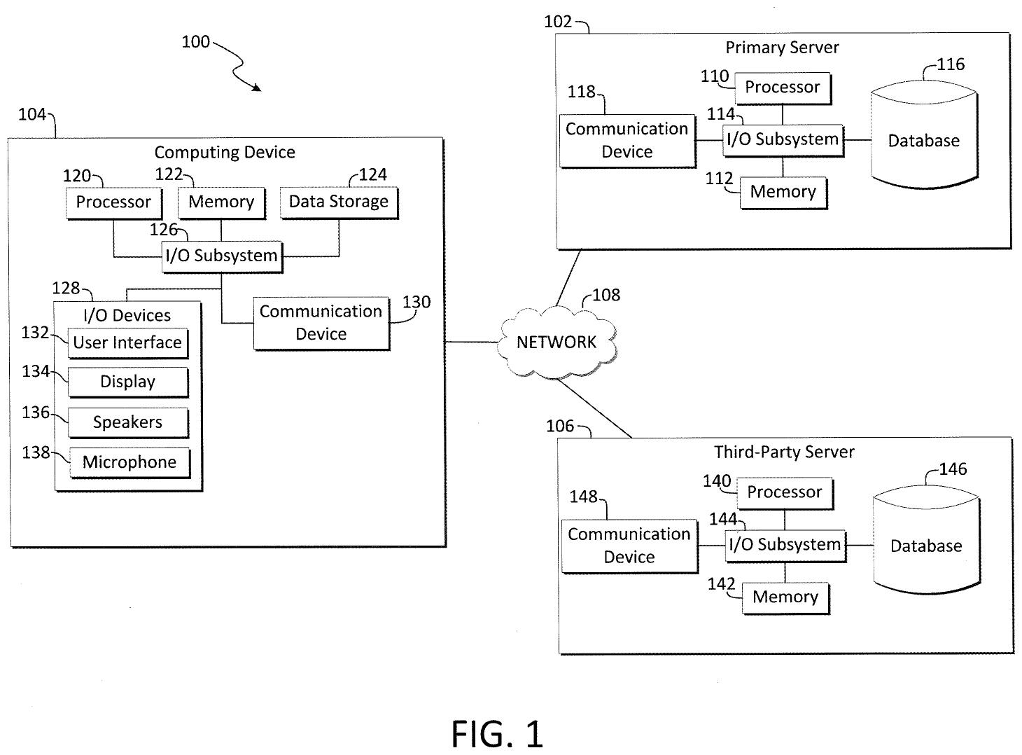

Referring now to FIG. 1, an illustrative system 100 for aggregating data to provide an application includes a primary server 102 connected to a computing device 104 and a third-party server 106 through a network 104. Although FIG. 1 shows only one primary server 102, one computing device 104, and one third-party server 106, there may be any number of these computing devices and servers. In use, as described below, the primary server 102 may manage, implement, and service an application. In one embodiment, the application may be embodied as a game. The primary server 102 may manage information on users of the application, such as application information, user profiles, contact information, and any other information that would be necessary to implement the application. Although referenced as users, in one embodiment, the users may be players of a game. Accordingly, the application information may be game information, user profiles may be game profiles, etc. In addition, the primary server 102 may aggregate data from the computing device 104 and the third-party server 106 in order to implement the application. The primary server 102 may receive data from the third-party servers 106 to generate application elements for a user of the computing device 104 to utilize on the computing device 104. Furthermore, the primary server 102 may integrate social features into the generated application to allow communication between several computing devices 104. To add to the social implementation, the primary server 102 may perform user acquisition management to retain users of the application and service the users to provide a more robust experience for the users. During implementation of the application, data will be generated that can be collected and analyzed by the primary server 102 to improve the system 100. The primary server 102 may manage the various backend components of the application. The implementation of the system 100 may be platform agnostic and can support both cloud and on premise installation. The system 100 may support geo clustering and have flexible servers that grow and shrink based on the load of the system 100.

The primary server 102 may be embodied as any type of computation or computer device capable of performing the functions described herein, including, without limitation, a computer, a multiprocessor system, a server, a rack-mounted server, a blade server, a cloud base service, a Virtual Server, a laptop computer, a notebook computer, a network appliance, a web appliance, a distributed computing system, a processor-based system, and/or a consumer electronic device. As shown in FIG. 1, the primary server 102 illustratively includes a processor 110, a memory 112, an input/output (I/O) subsystem 114, a database 116, and a communication device 118, and/or other components and devices commonly found in a server computer or similar computing device. Of course, the primary server 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor 110 in some embodiments.

The processor 110 may be embodied as any type of processor capable of performing the functions described herein. For example, the processor 110 may be embodied as a single or multi-core processor(s), digital signal processor, microcontroller, or other processor or processing/controlling circuit. The memory 112 may be embodied as any type of volatile or non-volatile memory or data storage capable of performing the functions described herein. In operation, the memory 112 may store various data and software used during operation of the compute device 102 such operating systems, applications, programs, libraries, and drivers. The memory 112 is communicatively coupled to the processor 110 via the I/O subsystem 114, which may be embodied as circuitry and/or components to facilitate input/output operations with the processor 110, the memory 112, and other components of the primary server 102. For example, the I/O subsystem 114 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 114 may form a portion of a system-on-a-chip (SoC) and be incorporated, along with the processor 110, the memory 112, and other components of the primary server 102, on a single integrated circuit chip.

The database 116 may be embodied as any type of device or devices configured for short-term or long-term storage of data such as, for example, memory devices and circuits, memory cards, hard disk drives, solid-state drives, non-volatile flash memory, or other data storage devices. The primary server 102 may also include a communication device 118, which may be embodied as any communication circuit, device, or collection thereof, capable of enabling communications between the primary server 102 and other devices and/or servers over the network 108. For example, the communication device 118 may be embodied as or otherwise include a network interface controller (NIC) for sending and/or receiving network data with remote devices. The communication device 118 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication.

In some embodiments, the primary server 102 may be embodied as separate servers in order to perform separate tasks, similar tasks, or a combination of separate and similar tasks. For example, there may be a separate primary server 102 to receive input from the computing device 104 and process that input and another separate primary server 102 to receive input from the third-party server 106.

An illustrative embodiment of the computing device 104 is shown in FIG. 1. The computing device 104 may be configured to receive data from the primary server 102 and send data to the primary server 102 to be processed and utilized to manage the application. The computing device 104 may be embodied as any type of computation or computer device capable of performing the functions described herein, including, without limitation, a computer, a multiprocessor system, a laptop computer, a notebook computer, a network appliance, a web appliance, a distributed computing system, a processor-based system, and/or a consumer electronic device. As shown in FIG.1, the computing device 104 illustratively includes a processor 120, a memory 122, a data storage 124, an input/output (I/O) subsystem 126, input/output (I/O) devices 128, and a communication device 130, and/or other components and devices commonly found in a similar computing device. In some embodiments, one or more of the illustrative components may be incorporated in, or otherwise form a portion of, another component. For example, the memory 122, or portions thereof, may be incorporated in the processor 120 in some embodiments. The various components of the computing device 104 function similarly to the similar components included in the primary server 102 as discussed above. The various components of the computing device 104 may also be similarly embodied as the components in the primary server 102. Similarly to the database 116 of the primary server 102, the data storage 124 may store information on the computing device 104.

The I/O Devices 128 may include a user interface 132, a display 134, speakers 136, and a microphone 138. As discussed below, these I/O devices 128 may be used to receive input from the user and output an application to the user. The user interface 132 may include any combination of input/output devices, such as, for example, buttons, keyboard, or a computer touchscreen. For example, the user may input account information through the user interface 132 to send to the primary server 102. The display 134 and speakers 136 may display the application and provide application audio for the user. In some embodiments, the microphone 138 may capture information verbally presented by the user. In another embodiment, the I/O devices 128 may include other devices to input and output information to and from the user on the computing device 104. The computing device 104 may send all of the information collected to the primary server 102.

An illustrative embodiment of the third-party server 106 is shown in FIG. 1. In the embodiment shown, the third-party server 106 may include many of the similar components as the primary server 102. The third-party server 106 may be configured to communicate with the primary server 102 and/or the computing device 104 in order to send data to the right destination. The third-party server 106 may be configured to communicate with both of the computing device 104 and the primary server 102. The third-party server 106 illustratively includes a processor 140, a memory 142, an I/O subsystem 144, a database 146, and a communication device 148. Each of the processor 140, memory 142, I/O subsystem 144, database 146, and communication device 148 functions similarly as the similar components of the primary server 102 as described above. Each of the processor 140, memory 142, I/O subsystem 144, database 146, and communication device 148 may also be embodied similarly to the corresponding components of the primary server 102.

In the embodiment shown, the third-party server 106 may be embodied as any type of computation or computer device capable of performing the functions described herein, including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. Of course, the third-party server 106 may include other or additional components, such as those commonly found in a server device (e.g., various input/output devices), in other embodiments. Additionally, in some embodiments, one or more of the illustrative components may be incorporated in, or otherwise form a portion of, another component. For example, the memory 142, or portions thereof, may be incorporated in the processor 140 in some embodiments.

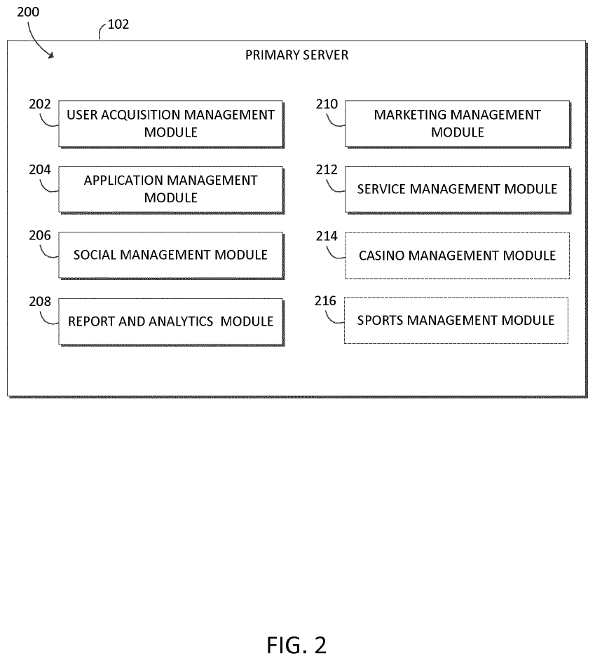

Referring now to FIG. 2, in an illustrative embodiment, the primary server 102 establishes an environment 200 during operation. The illustrative embodiment 200 includes a user acquisition management module 202, an application management module 204, a social management module 206, a report and analytics module 208, a marketing management module 210, and a service management module 212. Additionally, in some embodiments, the environment 200 may include a casino management module 214 and a sports management module 216. The various components of the environment 200 may be embodied as hardware, firmware, software, cloud solution, or a combination thereof. As such, in some embodiments, one or more of the components of the environment 200 may be embodied as circuitry or collection of electrical devices. It should be appreciated that, in such embodiments, one or more of the user acquisition management module 202, the application management module 204, the social management module 206, the report and analytics module 208, the marketing management module 210, the service management module 212, the casino management module 214, and/or the sports management module 216 may form a portion of the processor 110, the I/O subsystem 114, and/or other components of the primary server 102. Additionally, in some embodiments, one or more of the illustrative components may form a portion of another component and/or one or more of the illustrative components may be independent of one another. Also, although illustrated as being established by a single primary server 102, in some embodiments the environment 200 may be established by several primary servers 102 in communication over the network 108.

The user acquisition management module 202, which may be embodied as hardware, firmware, software, virtualized hardware, emulated architecture, and/or a combination thereof as discussed above, is configured to acquire users of the application through marketing campaigns and interaction with third party affiliates. The primary server 102 may plan an online campaign to acquire more users. To do so, the primary server 102 may integrate multiple channels for acquisition campaign management. For example, the primary server 102 may utilize a third party affiliate, email, search engines, call centers, media, etc. The user acquisition management module 202 may identify the potential end user for the application. That is, the user acquisition management module 202 may identify certain traits of the potential end user of the application, such as whether or not the end user generally likes RPG games, are heavily invested in social media, etc. These traits of the potential end user may be combined to generate personal data for the end user and later user related data to be tracked by the primary server 102 as described below. The primary server 102 may perform machine learning algorithms to determine possible traits for the potential end user based on data gathered on users of a variety of applications and match those traits to the features and traits of the application implemented by the primary server 102. Alternatively, in some embodiments, an administrator may input traits of the potential end user or user of the application implemented by the primary server 102.

After establishing the traits of the potential end user, the user acquisition management module 202 may filter between marketing campaigns based on the gathered personal data of the potential end user and other data sources, such as third party affiliates. For example, the user management module 202 may determine a social media marketing campaign would be best to acquire users if it is determined the end user frequently utilizes social media. In addition, the user management module 202 may dynamically adjust the marketing campaign if machine learning algorithms determine a certain user's life time value (LTV) is sufficient or above a certain threshold. For example, the user management module 202 may implement costlier marketing campaigns in order to acquire users with a high LTV. Life time value relates to the net profit attributed to an entire future relationship with the particular user. In some embodiments, the user acquisition management module 202 may integrate with various affiliate management platforms to acquire users.

The user acquisition management module 202 may generate customized landing pages to receive potential users. After an initial inquiry from a potential user, the user acquisition management module 202 may generate a lead if the inquiry is received from a specific email address or via a web form. The user acquisition management module 202 may prioritize certain leads above other leads based on various rules, such as the user's LTV or a determined high user interest in the application.

After acquiring the new user, the user acquisition management module 202 may generate a user profile and an incentive package for the new user. The user profile may include user contact information, user contact channels and contact rules, user billing information, and user data. The user contact information may be an email address to reach the user and/or any other details the user provides to establish contact. The user contact channels and contact rules may establish an email address and a phone number are provided, but the user requests to be contacted by email address only. The user may provide billing information, such as credit card information to be charged for services or for various application elements or components. For example, the user may be charged for buying additional in-application currency or additional application features. In addition, the user acquisition management module 202 may be integrated with several payment service providers (PSP), app stores, etc. to facilitate billing of the user. The incentive packers may include benefits and certain rates for the application implemented by the primary server 102. Users with higher LTV may receive better incentive packages to retain the user.

The user acquisition management module 202 may perform analysis and machine learning algorithms on the user's application behavior and how the user interacts with the application. This analysis may be used to determine the user's application behavior, such as when the user uses the application, what actions the user performs frequently, etc. The analysis compiles and generates user related data that includes the user's personal data, application use details, and other relevant data for the user, etc. This data may be stored in the database 116 of the primary server 102 or any other database to be accessed by the primary server 102. From the analysis, the user acquisition management module 202 may generate user statistics for the particular user that may include statistics associated with various application elements. For example, if the application was a betting game, the user statistics may include lifetime bet amounts, lifetime win amounts, big wins, etc.

The application management module 204, which may be embodied as hardware, firmware, software, virtualized hardware, emulated architecture, and/or a combination thereof as discussed above, is configured to manage elements of the application implemented by the primary server 102 and manage interaction with various front-end platforms, such as computing device 104. Various front-end platforms may include a native mobile, a cross-platform, web, TV, wearable, and others. The application management module 204 may manage the login mechanism for the application on a computing device 104. For example, the primary server 102 may receive requests from computing device 104 to login to the application. The application management module 204 may handle the login requests by creating a guest account for the application, integrating with social media sites for login in through third party affiliates, interacting with an email address of the user, or any other ways to handle login requests.

Furthermore, the application management module 204 may manage the application levels of the application implemented by the primary server 102. This may include managing the application economy and unlock features, screens, and/or unique features for certain levels. For example, certain features may be unlocked as the user progresses in levels, such as being able to use a multiplayer mode after an initial tutorial that advances the user's level. This may be the case for application implementations where the application is a game. Managing the application economy may include managing the application financials. For example, this may be managing a game economy and managing game financials. In another embodiment, the application economy may be based upon in application currency. To do so, the application management module 204 may monitor how much currency is available to all of the users and adjust various aspects to provide an enjoyable experience for the users. For instance, the application management module 204 may adjust daily bonuses higher for the users if there is a lack of in application currency. In addition, the application management module 204 may configure various application parameters, such as the daily bonus as described above. Other application parameters may include starting balance for users if currency is available in the application, bonuses throughout the application, such as bonus experience for awards on reaching certain levels, certain features that are available to the users.

In addition, the application management module 204 may manage support for the application as various issues are identified and new content is available to be pushed to the users. The updates may be downloaded as new components of the application to prevent reinstallation of the application. These updates may be sent through an app store or another medium. As another part of the app store experience, the application management module 204 may manage a rating system for the application. The rating system may trigger a “rate us” window based on various conditions. For example, the rating system may detect the user has used the application for an hour and has not yet given feedback for the application and as a result, request the user to provide feedback. The rating system may also detect whether the user preliminarily scores or rate the application below a threshold rating value and redirect the user to an internal feedback screen. This internal feedback screen may generate an issue to be resolved by an administrator. Alternatively, in some embodiments, if the rating is above the threshold rating value, the user may be redirected to the app store rating screen.

The application management module 204 may further create and manage business rules used to determine primary server 102 interactions with the users. For example, upon creation of a profile, the application management module 204 may send a welcome email to the new user. Further, the application management module 204 may send an inquiry to a user if the user decides to uninstall the application.

In some embodiments, the application may be managed remotely and so the primary server 102 may manage the application configuration remotely. The application configuration may be managed by the primary server 102 dynamically based on algorithms to adjust various components of the application as certain thresholds are reached or various conditions are met. For example, in an embodiment where the application is a game, upon reaching a threshold amount of in-game currency, certain application configurations may be adjusted accordingly to maybe reduce or increase the amount of in-game currency. Alternatively, in some embodiments, an administrator may input various application configurations for the application.

The social management module 206, which may be embodied as hardware, firmware, software, virtualized hardware, emulated architecture, and/or a combination thereof as discussed above, is configured to manage the social aspect of the application. This may include leaderboards that position users in various ways, such as global rankings, country ranking, and/or social activities (sharing, posting about the application). For instance, leaderboards may be implemented for a game implementation of the application where friends may compare the scores they receive in the game. The social management module 206 may send out acknowledgements on friend's winnings or accomplishments. For example, friends of a user may be acknowledged with a relevant popup or tooltip message in response to the user winning, accomplishing an achievement, etc. The social management module 206 may integrate with social media sites and/or phone contact book to invite further friends to join the game. In addition, the social management module 206 may be integrated with social media sites and/or phone contact book to share achievements, progress, and various elements through those channels.

During implementation of the application, the social management module 206 may retrieve user information and display real data during a session of the application for all participants of the session. For example, if the session includes a room of participants, each of the participants may display their user information, such as level and amount of currency, etc. The social management module 206 may also be configured to invite friends of the user to empty slots of the session. Further, the social management module 206 may manage chats within the session or outside of the session. For example, in room chat may be sent to each user in the session. Private chats may also be established between users. The chat rooms may also implement “likes” or gift giving between participants. Users may be notified of receiving a “like” or a gift from another user. Other features may be incorporated into the chat rooms, such as a report feature in case one participant is being disruptive to other users' experiences. While these features may be implemented in chat rooms, these features may also be implemented outside of the chat rooms and application sessions.

The social management module 206 may manage the connection features for users interacting with other users. For example, the social management module 206 may send connection requests to users from friends to establish application sessions. These requests may have a predetermined time to expire. The expiration date may be determined by the social management module 206 or set by another user sending the request.

The report and analytics module 208, which may be embodied as hardware, firmware, software, virtualized hardware, emulated architecture, and/or a combination thereof as discussed above, is configured to generate reports and perform the analysis as described above. To perform the analysis, the report and analytics module 208 may utilize machine learning algorithms on all of the collected user related data. That is, the primary server 102 collects data during the application sessions, user application behaviors, etc. and conducts an analysis on various aspects of the user's behavior. The analysis provides insight on user's future application utilization, usage, and/or buying behavior as well as other user behaviors. This allows the primary server 102 to perform certain actions in response to detected user behaviors as described above.

After generating the data on the users, the report and analytics module 208 may generate a customized report. This report may include a customized dashboard of various reports for the application. In addition, the report may combine data generated by the primary server 102 and data received from third party providers. These reports may be highly specific to a certain user or it may include a plurality of users of the application. Various timelines may be implemented for these reports. For example, the generated report may be for a 1 day behavior or several day behavior or lifetime behavior. The reports may include transactions made by user and social interactions of a user with other users. Other reports may include financial reports, user retention reports, life time value reports, and other reports to be generated from the collection of data of the primary server 102. The analytics provides feedback into the application to customize campaign personalization, personalized retention plans, application configurations, and other application aspects as described above.

The marketing management module 210, which may be embodied as hardware, firmware, software, virtualized hardware, emulated architecture, and/or a combination thereof as discussed above, is configured to integrate with third party providers to interact with users and perform push notifications to the users. The marketing management module 210 may integrate with third party mass email providers to reach out to potential users or contact all existing users. In implementing the mass email provider, the marketing management module 210 may use email templates to correspond with users. In addition, data filtering and segmentation may be used to identify certain users to email. The marketing management module 210 may integrate with third party push notification providers to send push notifications to native mobile apps. These notifications may remind users to return to use the application and/or notify users of requests to join application sessions. For example, these may be notifications for the user to return to play a game. Furthermore, the marketing management module 210 may export data to third party providers to provide insight on the users' behaviors. To do so, the marketing management module 210 may generate documents containing the data.

The service management module 212, which may be embodied as hardware, firmware, software, virtualized hardware, cloud service, emulated architecture, and/or a combination thereof as discussed above, is configured to provide support for the users in interacting with the application. This may include managing a service level agreement, organization level agreement, a self-service portal, frequently asked questions (FAQ) repository, and other multichannel support systems. The service management module 212 may receive various inquiries from users and compile them into cases to be addressed by the primary server 102, such as identified bugs or issues with the application. The service level agreement is dictated by setting relevant business rules and defines triggers and events related to the generated cases. For example, a business rule may be set to respond to cases labeled as “Urgent” within an hour or otherwise email a manager to attempt to progress the case to completion. The organizational level agreement may define certain rules and triggers within an internal organization performance management to progress cases to completion. For example, if a generated case has been passed to a financial department after an initial review of the generated case and does not progress after a predetermined time period like 5 hours, then reminders or emails may be generated to appropriate personnel to progress the case to completion.

The service management module 212 may manage a self-service portal that receives users that need guidance through an issue with the application. The self-service portal may provide instructions for the user to try to resolve any issues. In addition, the self-service portal may redirect the user to a FAQ repository where other users may have addressed the particular issue faced by the user. If certain issues become a reoccurring problem for most users, the primary server 102 may implement an application configuration if possible to address the issue or provide some insight in application to prevent the issue from occurring.

In some embodiments, the environment 200 may include a casino management module 214 as described above. The casino management module 214, which may be embodied as hardware, firmware, software, virtualized hardware, emulated architecture, and/or a combination thereof as discussed above, is configured to manage application elements and integrate with third party providers. The use of the casino management module 214 may be for a game implementation of the application. One particular application that the primary server 102 may implement may be a social betting game. In the social betting game, the casino management module 214 may perform lobby management to order slot machine layouts. Further, the casino management module 214 may manage the slot machine metadata and perform the configurations remotely to configure the game immediately for the users to utilize. The reels, symbols, and pay tables of the slot machine may be configured by the casino management module 214. The reels of the slot machine may be configured so that a random number generator is used to randomize the result of the slot machine. Alternatively, in some embodiments, the reels of the slot machine may be configured to have predefined results managed by the casino management module 214. The slot machines may have more than 10 built-in slot machine features.

After an initial setup of the slot machines, the casino management module 214 may implement a machine RTP (Return to Player) simulator to test and simulate a predetermined amount of games to ensure that the math and configurations are as planned based on the predetermined amount of games. For example, the casino management module 214 may simulate one million games. This simulation provides an administrator a check to determine whether the configuration should be implemented into the actual game or not.

The casino management module 214 may further be configured to manage a regular and progressive jackpot for the game. In addition, the casino management module 214 may manage tournaments that start after a predetermined time period lapses. For example, the tournaments may start every few minutes with the leading participants winning a certain amount of prize.

In addition, the casino management module 214 may be integrated with several third party providers. More specifically, the casino management module 214 may be integrated with marketing websites, third party content providers, and third party fraud detection tools. The casino management module 214 may use a built in fraud detection mechanism to determine if fraud has occurred based on an analysis on the collected data of user related data, user behavior, etc. After detection of fraud, the casino management module 214 may issue a report to the administrator or perform a corrective action to remove the user committing fraud from the game. Alternatively, in some embodiments, the casino management module 214 may configure the game to eliminate the possibility of the particular fraud from reoccurring.

In some embodiments, the environment 200 may include a sports management module 216 as described above. In one embodiment, the sports management module 216 may be included in a game implementation of the application. The sports management module 216, which may be embodied as hardware, firmware, software, virtualized hardware, emulated architecture, and/or a combination thereof as discussed above, is configured to manage retrieval of data and statistics for a plurality of sports. To do this, the sports management module 216 may be integrated with the leading sports data providers. The retrieval of data regarding the plurality of sports may include over retrieving data on 80 different sport types, all related leagues, players and statistics. The sports management module 216 may enable certain sport types, leagues, match per game or based on the user. For example, the user may not have the level requirement to enable a certain sport type. The sports management module 216 may push pre-match statistics and in-game statistics to the computing device 104. The pre-match statistics may include information about the teams that are playing, the league, players, and pre-match odds. The in-game statistics may include the score, ball possession, real-time in-game statistics, and in-game odds.

The sports management module 216 may perform an analysis on the data using machine learning algorithms for predictive analytics related to game results, expected game situations, odds and more. In conjunction with the predictive analytics, the sports management module 216 may receive bets from users of the application to receive a reward based on who wins the sports game in the scenario the application implemented by the primary server 102 is embodied as a social sports betting game. The sports management module 216 may determine a bet in and a bet out during the sports game using in-game odds. For instance, the bet in may be a value that a user needs to pay to bet on the sports game and the bet out value may be the value that the user receives if they were to cash out on the sports game. The sports management module 216 may manage a pool configuration during a multiplayer or peer to peer betting. That is, many users may bet on a specific sports game.

Similarly to the casino management module 214, the sports management module 216 may be integrated with several third party providers. That is, the sports management module 216 is also integrated with marketing websites, third party content providers and third party fraud detection tools. The integration with the various third party providers function similarly to how the casino management module 214 is integrated with the third party providers as described above.

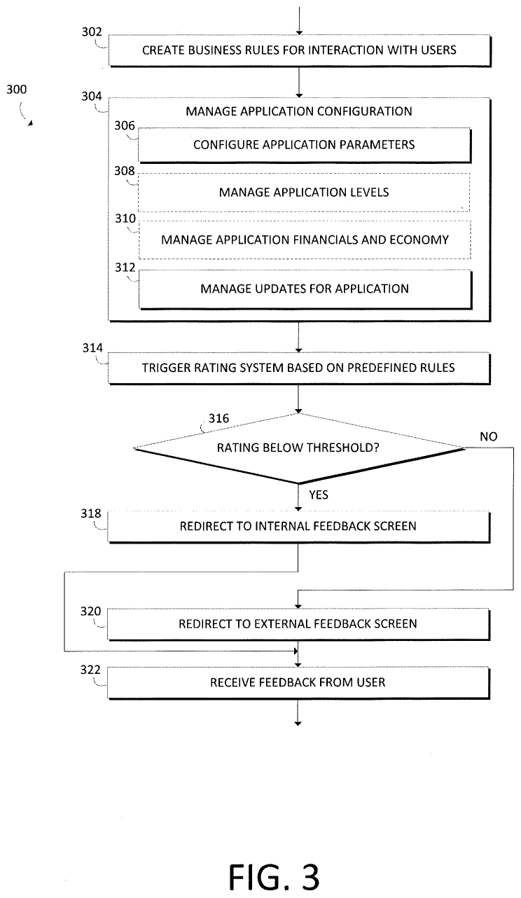

Referring now to FIG. 3 in use, the primary server 102 may execute a method 300 for configuring an application and receiving feedback from a user through the primary server 102. The method 300 begins with block 302 in which the primary server 102 creates business rules for interaction with users. For example, the primary server 102 may identify actions to perform given certain conditions, such as emailing a new user a welcome email to begin the application experience.

In block 304, the primary server 102 manages the application configuration. To do so, the primary server 102 may configure the application parameters in block 306. Configuration of the application parameters may include adjusting starting values/features and other parameters for the user application experience. For example, in the case that the application is a game, the application parameters may be directed to what a user starts with playing the game. In addition, in some embodiments, in block 308, the primary server 102 manages the application levels, which include manipulating what is available to users at certain levels. This encourages continued application use when the users are given new features at various levels. In some embodiments, in block 310, the primary server 102 may also manage in-application financials and economy to manage the application configuration. In some instances, such as when the application is embodied as a social betting game, there is an in-game economy to manage as described above. As such, the primary server 102 may manipulate various application parameters to adjust and manage the in-application financials and economy. In block 312, the primary server 102 manages updates for the application. This may include pushing out bug fixes and new features to the users through updates that can be downloaded from the web or an app store.

In block 314, the primary server 102 may trigger a rating system based on predefined rules. For example, the primary server 102 may determine that the user has used the application for a predetermined period of time and that the user has not provided feedback on the application. For example, the application may be embodied as a game and the primary server 102 may determine that the user has played the game for a predetermined period of time. The primary server 102 may retrieve the user feedback in various forms. Preliminarily, in some embodiments, the primary server 102 may request the user to rate the application on a spectrum, such as 1 to 5.

In block 316, the primary server 102 determines whether the rating was below a certain threshold value. If it is determined that the rating received by the user was below a threshold value, the method 300 advances to block 318. However, if it is determined that the rating received by the user was not below a threshold value, then the method 300 branches ahead to block 320.

In block 318, the primary server 102 redirects the user to an internal feedback screen to receive the user feedback to allow the application administrator to handle any issue highlighted in the feedback provided by the user. In block 320, the primary server 102 redirects the user to an external feedback screen. For example, the primary server 102 may pull up an app store to give the user the opportunity to share their experience with other potential users.

In block 322, the primary server 102 receives the feedback from the user. Subsequently the primary server 102 may implement a change as a result of the feedback. The primary server 102 may maintain a running log of identified issues and positively accepted features of the application to fix problems and improve upon the strengths of the application.

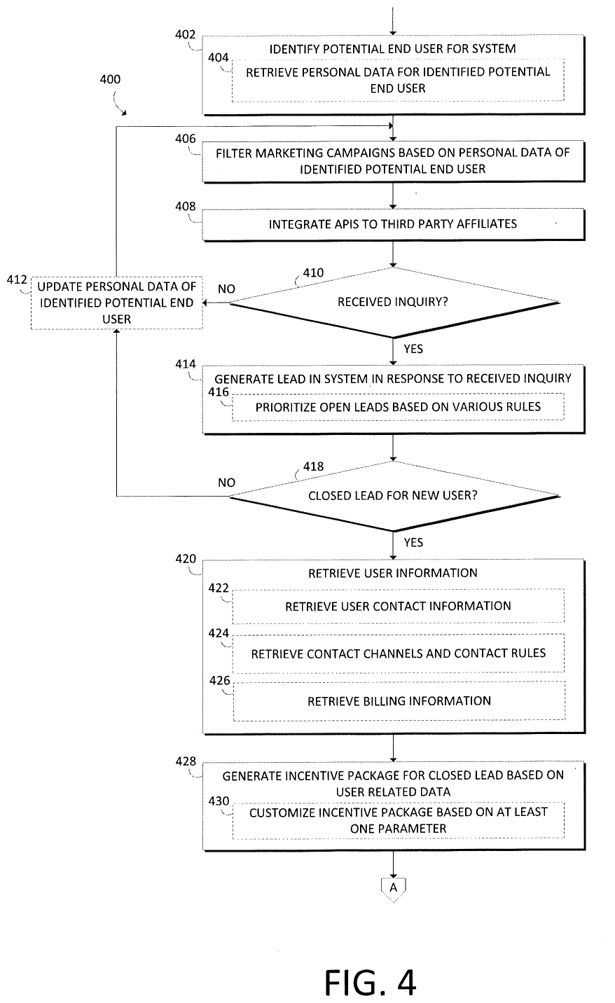

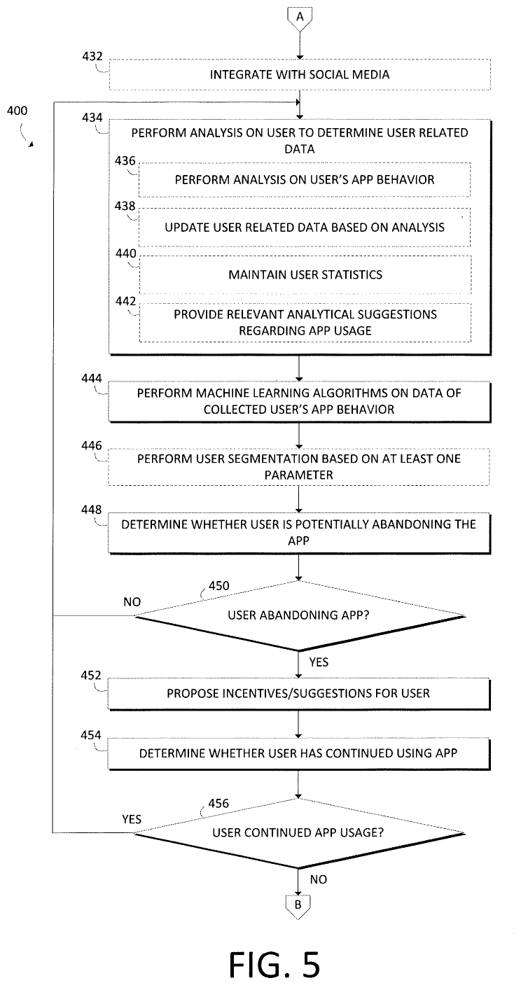

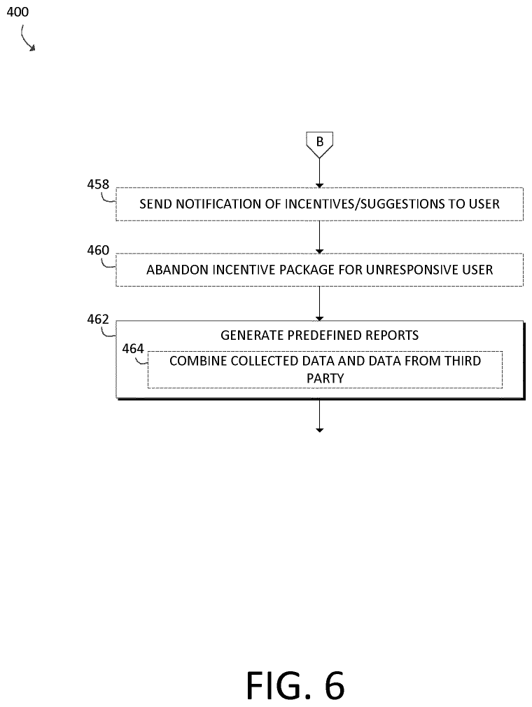

Referring now to FIG. 4, FIG. 5, and FIG. 6 in use, the primary server 102 may execute a method 400 for acquiring users, retaining users, and generating reports through the primary server 102. The method 400 begins with block 402 in which the primary server 102 identifies a potential end user for the system 100. The potential end user may be identified by the traits of the application and matching traits of the potential end user that are compatible to the traits of the application as described above. In some embodiments, in block 404, the primary server 102 may retrieve personal data for the identified potential end user. This may include retrieving personal data from third party providers to determine users who may be interested in the application implemented by the primary server 102.

In block 406, the primary server 102 may filter marketing campaigns based on the personal data of the identified potential end user. The tailoring of the marketing campaigns make it more cost effective to pursue the identified potential end user rather than spending money on various marketing campaigns to try to appeal to the wrong market. For example, if the application implemented by the primary server 102 is embodied as a game with a sports aspect, then money may be well spent on marketing campaigns targeted to a sports watching audience. The primary server 102 may filter from a plurality of different marketing campaigns to use one marketing campaign to best reach the identified potential end user.

In block 408, the primary server 102 integrates application programming interfaces (APIs) with third party affiliates to allow easy implementation of establishing a user profile on different third party providers. Furthermore, the primary server 102 may integrate the APIs with various marketing companies to expand market exposure to the application.

After the initial set up of the marketing campaigns, in block 410, the primary server 102 determines whether there is a received inquiry. The received inquiry may be from an interested potential user. If it is determined that there is no received inquiry, in some embodiments the method 400 may advance to block 412. Alternatively, the method 400 may loop back to the beginning of block 406 to return to monitoring for received inquiries after selecting the same marketing campaigns. In some embodiments, the method 400 may loop back around to block 410 to continue monitoring for received inquiries. If it is determined that there is a received inquiry, the method 400 advances to block 414.

In some embodiments, in block 412, the primary server 102 may update the personal data of the identified potential end user. This may be done based upon machine learning algorithms to refine the traits of the potential end user or an administrator may adjust the traits of the potential end user. After updating the personal data of the identified potential end user, the method 400 adjusts the marketing campaign in block 406, integrates to various third party affiliates in block 408, and continues monitoring for received inquiries in block 410.

In block 414, after receiving an inquiry, the primary server 102 generates a lead in the system 100 in response to the received inquiry. The lead is an open case with a potential end user to be a new user of the application implemented by the primary server 102. The primary server 102 follows the leads to try to make the application appealing for the potential new user to try and eventually spend money. In some embodiments, in block 416, the primary server 102 prioritizes open loads based on various rules. These rules may include the LTV of the potential user or the potential user interest in the application as described above.

In block 418, the primary server 102 determines whether or not a lead has been closed for a new user. That is, if the primary server 102 has successfully received a new user from one of the generated leads. If it is determined that a lead has not been closed, then the method 400 advances to block 412. However, if it is determined a lead has been closed for a new user, then the method 400 advances to block 420.

In block 420, the primary server 102 retrieves user information. The retrieval of information may be done through third party providers or may be directly inquiring the user for information to be inputted into the system 100. In some embodiments, in block 422, the primary server 102 may retrieve user contact information, such as phone number or email address to reach the user. In some embodiments, in block 424, the primary server 102 may retrieve contact channels and contact rules, such as the email address and a preference to utilize the email address for communication between system 100 and the user. In some embodiments, in block 426, the primary server 102 may retrieve billing information from the user. In some embodiments the billing information may be linked to an app store account or another payment service provider that the primary server 102 has access to and only needs permission from the user to access.

After establishing the user profile for the user related data, in block 428, the primary server 102 generates an incentive package for the closed lead based on user related data. The incentive package includes benefits and rates for the user to utilize. In some embodiments, in block 430, the primary server 102 customizes the incentive package based on at least one parameter. For example, the primary server 102 may customize the incentive package based on the user's LTV. This attempts to preemptively retain the user by providing appealing rates and attractive benefits to using the application.

In some embodiments, in block 432, the primary server 102 may integrate with social media based on a preference from the user to implement social media. Alternatively, the primary server 102 may create a guest account for the user. Integration of social media enables various social features as described above.

In block 434, the primary server 102 performs an analysis on the user to determine user related data. Previously the primary server 102 collected information for the user's profile. User related data includes the user information and the user's application behavior, spending trends, and other characteristics identified for the user. In some embodiments, in block 436, the primary server 102 may perform an analysis on the user's application behavior. This may include how often the user uses the application or spends money on the application along with other application behaviors. In some embodiments, in block 438, the primary server 102 may update the user related data for the user based on the perform analysis on the user. This enables the primary server 102 to keep a current updated profile for the user. In some embodiments, in block 440, the primary server 102 may also maintain user statistics for the user. The user statistics may be used by the administrator to identify trends among users to best optimize interactions with the users. For example, if the primary server 102 identifies that users use the application during a certain time of the day, then the primary server 102 may perform routine maintenance outside of those times. In some embodiments, in block 442, the primary server 102 may also provide relevant analytical suggestions regarding the application usage to the user. For example, the primary server 102 may provide insights on how to user the application to facilitate a better experience for the user. For instance, if the application was embodied as a game, then the primary server 102 may provide insights and tips on how to play the game.

In block 444, the primary server 102 performs machine learning algorithms on data of collected users' application behavior. This implementation of machine learning algorithms provides insight on user trends throughout the application. For example, the primary server 102 may determine that there was a decrease in spending during a certain period of time that was out of the norm.

In some embodiments, in block 446, the primary server 102 may perform user segmentation based on at least one parameter. For example, the primary server 102 may perform user segmentation for users of a specific country that have not used the application for three days. This allows the primary server 102 to group specific users to identify reasons why certain things may be happening. For example, the cause of decline in application usage may be attributed to a holiday in a specific country.

In block 448, the primary server 102 follows up with the machine learning algorithms performed on the collected users' application behavior to determine whether the user(s) is potentially abandoning the application. This may be determined based on identified trends typical of users who later abandon the application. For example, the primary server 102 may identify that as a user slowly stops using the application the user may not need the application as much. Other trends may be used and user segmentation may aid in identifying causes as well.

In block 450, the primary server 102 determines whether the user is potentially abandoning the application based on the analysis done in block 448. If it is not determined that the user is abandoning the application, then the method 400 returns to block 434 to continue performing analysis on the users. However, if it is determined that the user intends to abandon the application, then the method advances to block 452.

In block 452, the primary server 102 proposes incentives and/or suggestions for the user to try to entice the user to continue using the application. For instance, in one embodiment where the application is a game, these may include huge one day bonuses or a special deal to be bought in the game.

After attempting to retain the user in block 452, in block 454 the primary server 102 determines whether the user has continued using the application. This may be determined if there has been any increase in activity of the user. In other embodiments, this may be determined based on whether the activity of the user is above a threshold amount of time spent in the application. For instance, in one embodiment where the application is embodied as a game, playing the game momentarily may suggest that the user is still not engaged and may end up not playing the game after a period of time.

In block 456, the primary server 102 determines whether the user has continued to use the application based on the analysis of block 454. If the user has returned to using the application for an amount of time above a threshold amount of time, the method 400 returns to block 434 to continue performing analysis on the users. However, if the user has not returned to using the application, the method 400 may advance to either of blocks 458, 460 or 462.

In some embodiments, in block 458, the primary server 102 may send an additional notification of incentives and/or suggestions to the user to resume using the application as another effort to reinstate user interest in the application.

In some embodiments, in block 460, the primary server 102 may abandon the incentive package for any unresponsive users. Alternatively, the primary server 102 may retain the user profiles in case a user is taking a break from the application for other current endeavors. For example, the user may be traveling abroad and may not have time to use the application.

In block 462, the primary server 102 may generate predefined reports. The predefined reports may include specific user focused reports (reports on personal information gather from his social and phone based on permissions allowed by user and behavior for a predefined timeframe) and specific user detailed reports (specific user focused reports and additional transactional details). In addition, the predefined reports may include social reports to identify user's social connections with friends that the user invited to the an application session. Further, the predefined reports include financial reports, user retention reports, and LTV reports and/or any other reports that can be generated from the collected data. In some embodiments, in block 464, the primary server 102 combines the collected data and the data from third party providers to generate the predefined reports. The reports may be customizable and presented in dashboard as described above. The reports may be used to make decisions on managing application configurations and/or any other decision to implement the application.

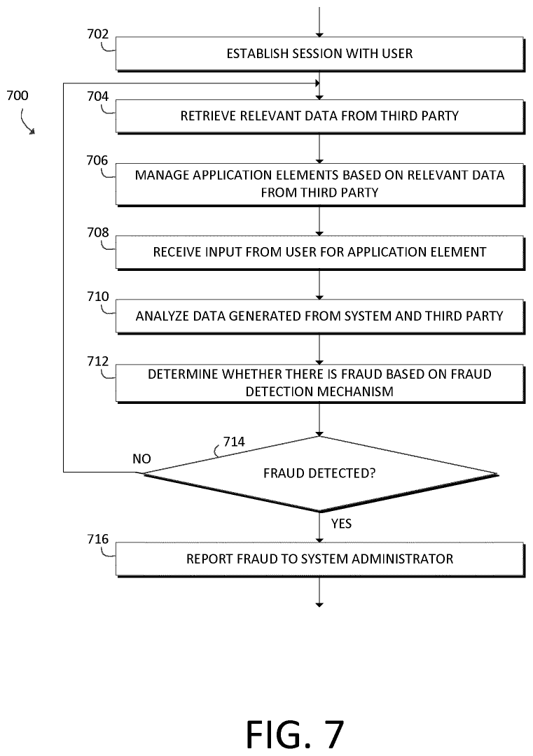

Referring now to FIG. 7 in use, the primary server 102 may execute a method 700 for establishing a session with the user and monitor application data for fraud through primary server 102. The method 700 begins with 702 in which the primary server 102 establishes a session with the user. Usually the user utilizes the computing device 104 to connect to the primary server 102 to use the application. In other embodiments, the computing device 104 may connect to the primary server 102 to establish a session.

In block 704, the primary server 102 retrieves relevant data from third party providers. In one embodiment, the application implemented by the primary server 102 is a social sports betting game as described above. The primary server 102 may retrieve data on sports to be utilized by the users to make a decision in the game. The sports data retrieved may be data on teams, leagues, different sport types, etc. as described above. In other embodiments, the primary server 102 may retrieve other data that may be relevant to the game. For example, if the game pertains to trivia, the primary server 102 may retrieve trivia information from a third party provider.

In block 706, the primary server 102 manages application elements based on relevant data from a third party. In one embodiment, the application elements may include slot machines that utilize data from a sports data provider to implement a sports betting game. For example, the slot machines may generate a betting situation for a specific sports game.

In block 708, the primary server 102 received input from the user for the application element. In one embodiment, the primary server 102 receives a bet for the sports game if the application element is embodied as a slot machine. The primary server 102 may perform further calculations after receiving user input, such as determining whether the user wins the bet or not if the application is embodied as a social sports betting game. In some scenarios for when the application is embodied as a social sports betting game, the user may have a bet out value as described above.

After receiving input from the user for the application element, in block 710, the primary server 102 analyzes data from the system 100 and third party providers. This may include performing machine learning algorithms or implementation of third party tools.

In block 712, the primary server 102 determines whether there is fraud based on a fraud detection mechanism. The primary server 102 performs the analysis in block 710 to identify trends that may be indicative of fraud.

In block 714, the primary server 102 determines whether fraud has been detected. If there has been no fraud detected, then the method 700 returns to the top of block 704 to continue the session with the user. If fraud is detected, the method 700 advances to block 716.

In block 716, the primary server 102 reports the fraud to a system administrator. Alternatively, in some embodiments, the primary server 102 may perform an action to address the fraud as described above.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

1-46. (canceled)

47. A system for acquisition and retention of users for an application, the system comprising:
a user acquisition management module to identify a trait of a potential user for the application;
a marketing management module to filter a plurality of marketing campaigns based on the identified trait of the potential user, wherein the marketing management module is further to implement the filtered marketing campaign to reach the potential user;
a report and analytics module to generate a predefined report,
wherein the user acquisition management module is further to retrieve user information in response to acquisition of a new user,
wherein the report and analytics module is further to perform an analysis on the new user's application behavior to generate user related data, and
wherein the predefined report is based on the user related data.

48. The system of claim 47, wherein to implement the filtered marketing campaign comprises to integrate an application programming interface with a third party affiliate.

49. The system of claim 47, wherein acquisition of the new user comprises to monitor for an inquiry from the potential user and to generate a lead in response to reception of an inquiry.

50. The system of claim 49, wherein:
the lead is prioritized among other open leads based on at least one rule, wherein the at least one rule includes at least one of a potential user interest in the application and a determined life time value of the lead, and
acquisition of the new user further comprises to closing the lead in response to confirmation of the new user.

51. The system of claim 47, wherein the user acquisition management module is further to retrieve user information to add to the user related data, wherein:
to retrieve user information further comprises at least one of to retrieve user contact information, retrieve contact channels and contact rules, or retrieve billing information,
the user acquisition management module is further to generate an incentive package for the new user based on the user related data, wherein the incentive package includes benefits and rates for in-application purchases for the new user, and
the user acquisition management module is further to customize the incentive package based on at least one parameter, wherein the at least one parameter includes a life time value of the new user.

52. The system of claim 47, further comprising a social management module to integrate social media of the new user and to provide social features for the new user.

53. The system of claim 47, wherein the report and analytics module is further to maintain user statistics and provide relevant analytical suggestions regarding application use.

54. The system of claim 47, wherein the report and analytics module is further to perform machine learning algorithms on the generated user related data and perform user segmentation based on at least one parameter, wherein the at least one parameter includes a country of origin, a time since last application use, and an amount of money spent on the application.

55. The system of claim 47, wherein the user acquisition management module is further to determine whether the new user is in consideration to abandon the application, wherein the user acquisition management module is further to provide new incentives and suggestions for the new user in response to a determination that the new user is in consideration to abandon the application, wherein the user acquisition management module is further to identify whether the user has continued application use in response to provision of the new incentives and suggestions, wherein the user acquisition management module is further to send a notification of incentives and suggestions for the new user in response to an identification that the new user has not continued application use, wherein the user acquisition management module is further to abandon the new user in response to an identification that the new user has not continued application use.

56. The system of claim 47, wherein:
the predefined report includes at least one of a specific user focused report, a specific user detailed report, a social report, a financial report, a user retention report, or a life time value report, and
to generate the predefined report comprises to combine the user related data with data received from a third party provider.

57. A method for acquiring and retaining users for an application, the method comprising:
identifying, by a server, a trait of a potential user for the application;
filtering, by the server, a plurality of marketing campaigns based on the identified trait of the potential user;
implementing, by the server, the filtered marketing campaign to reach the potential user;
generating, by the server, a predefined report;
retrieving user information in response to acquiring a new user;
performing an analysis on the new user's application behavior to generate user related data, wherein the predefined report is based on the user related data.

58. The method of claim 57, wherein implementing the filtered marketing campaign comprises integrating an application programming interface with a third party affiliate.

59. The method of claim 57, wherein acquiring of the new user comprises monitoring for an inquiry from the potential user and generating a lead in response to receiving an inquiry, wherein the lead is prioritized among other open leads based on at least one rule, wherein the at least one rule includes at least one of a potential user interest in the application and a determined life time value of the lead, wherein acquiring the new user further comprises closing the lead in response to confirming the new user.

60. The method of claim 57, further comprising:
retrieving, by the server, user information to add to the user related data, wherein retrieving user information further comprises at least one of retrieving user contact information, retrieving contact channels and contact rules, or retrieving billing information,
generating, by the server, an incentive package for the new user based on the user related data, wherein the incentive package includes benefits and rates for in-application purchases for the new user,
customizing, by the server, the incentive package based on at least one parameter, wherein the at least one parameter includes a life time value of the new user.

61. The method of claim 57, further comprising integrating, by the server, social media of the new user and providing social features for the new user.

62. The method of claim 57, further comprising maintaining, by the server, user statistics and providing relevant analytical suggestions regarding application use.

63. The method of claim 57, further comprising performing, by the server, machine learning algorithms on the generated user related data and performing user segmentation based on at least one parameter, wherein the at least one parameter includes a country of origin, a time since last application use, and an amount of money spent on the application.

64. The method of claim 57, further comprising:
determining, by the server, whether the new user is in consideration of abandoning the application,
providing, by the server, new incentives and suggestions for the new user in response to determining that the new user is considering to abandon the application,
identifying, by the server, whether the user has continued application use in response to providing the new incentives and suggestions,
sending, by the server, a notification of incentives and suggestions for the new user in response to identifying that the new user has not continued application use, and
abandoning, by the server, the new user in response to identifying that the new user has not continued application use.

65. The method of claim 57, wherein the predefined report includes at least one of a specific user focused report, a specific user detailed report, a social report, a financial report, a user retention report, or a life time value report.

66. The method of claim 57 wherein generating the predefined report comprises combining the user related data with data received from a third party provider.
